(19) United States
(12) Patent Application Publication
(10) Pub. No.: US 2008/0119267 A1
(43) Pub. Date: May 22, 2008

(54) PLASTIC ROLL UP GAMING TABLET

(76) Inventor: Christine Denlay, Las Vegas, NV (US)

Correspondence Address: MCANDREWS HELD & MALLOY, LTD, 500 WEST MADISON STREET, SUITE 3400, CHICAGO, IL, 60661, US

(21) Appl. No.: 11/936,648

(22) Filed: Nov. 7, 2007

Related U.S. Application Data
(60) Provisional application No. 60/858,055, filed on Nov. 10, 2006.

(51) Int. Cl. A63F 9/24; A63F 13/00

(52) U.S. Cl. 463/29; 463/31

(57) ABSTRACT

Certain embodiments provide systems and methods for mobile game play. A system includes a gaming processor facilitating game play in a gaming environment. The gaming processor is adapted to facilitate both in-person and mobile game play within a certain monitored area. The system also includes a sentinel monitoring data transmissions in the monitored area and authorizing activation of electronic devices in the monitored area based on an authentication of the electronic device. The system further includes a portable electronic gaming device for mobile game play. The portable electronic gaming device is adapted to provide identification information to the sentinel for authentication and to provide game play input to the gaming processor to facilitate mobile game play. Upon authorization of the portable electronic gaming device for activation by the sentinel, the processor facilitates remote game play with the portable electronic gaming device and at the gaming processor.

### RELATED APPLICATIONS

The present application claims priority to U.S. Provisional Patent Application No. 60/858,055 filed on Nov. 10, 2006, entitled “Plastic Roll Up Tablet,” which is herein incorporated by reference in its entirety.

### BACKGROUND OF THE INVENTION

The present invention generally relates to a gaming system. In particular, the present invention relates to a portable electronic gaming tablet for remote or mobile game play.

Transmission of electronic signals in a gaming environment is becoming increasingly commonplace. Transmission of electronic signals invites greater opportunities for interference and tampering in a gaming environment which is intended to be highly regulated and secure.

Casinos utilize chips, such as poker-style chips, to represent a player's funds. Electronic chips may be used to provide greater flexibility, as well as greater capacity to track and relay information, for casinos, players, and manufacturers alike.

In addition, players may have difficulty in making change with chips or obtaining new chips easily. For example, a player may have several $100 chips, but may desire to wager only $20. The player may have to leave a game to change chips and/or to acquire more chips. Electronic gaming chips having an adjustable value may provide such flexibility but introduce an element of gaming system vulnerability to outside attack or interference which cannot be remedied using current systems and methods.

### BRIEF SUMMARY OF THE INVENTION

Certain embodiments provide systems and methods for mobile gaming in a gaming environment.

Certain embodiments provide a portable gaming system including a portable electronic gaming table. The portable electronic gaming table includes a display providing information to a user. The information includes authentication information and game play information. The portable electronic gaming table also includes a two-way communication device transmitting information from the portable electronic gaming table and receiving information relating to authorization and game play at the portable electronic gaming table. The portable electronic gaming table further includes an input mechanism accepting input from the user for user identification, game play and service request. Additionally, the portable electronic gaming table includes a processor facilitating remote identification, authorization and game play in conjunction with a remote electronic gaming device to enable the user to remotely participate in game play within a certain monitored area. The two-way communication device transmits identification information to the remote electronic gaming device, and the processor facilitates remote game play, based on user input and activity at the remote electronic gaming device, in conjunction with the remote electronic gaming device upon receipt of authorization from the remote electronic gaming device.

In certain embodiments, the portable electronic gaming table includes a flexible, waterproof housing and flexible circuitry to allow the portable electronic gaming table to be rolled up, for example.

Certain embodiments provide a method for portable, remote game play in a gaming environment using a portable gaming table and an electronic gaming device. The method includes transmitting an identification signal from a portable gaming table to an electronic gaming device. The method also includes receiving an authorization signal from the electronic gaming device at the portable gaming table. Additionally, the method includes receiving game information from the electronic gaming device at the portable gaming table. The method further includes transmitting user input regarding wagering and game play from the portable gaming table to the electronic gaming device. In addition, the method includes facilitating remote game play between the portable gaming table and the electronic gaming device based on user input at the portable gaming table and activity at the electronic gaming device.

Certain embodiments provide a system for mobile game play. The system includes a gaming processor facilitating game play in a gaming environment. The gaming processor is adapted to facilitate both in-person game play and mobile game play within a certain monitored area. The system also includes a sentinel monitoring data transmissions in the certain monitored area. The sentinel authorizes activation of electronic devices in the certain monitored area based on an authentication of electronic device identity. The system further includes a portable electronic gaming device for mobile game play. The portable electronic gaming device is adapted to provide identification information to the sentinel for authentication and is adapted to provide game play input to the gaming processor to facilitate mobile game play. Upon authorization of the portable electronic gaming device for activation by the sentinel, the processor facilitates remote game play based on user input and activity at the portable electronic gaming device and at the gaming processor.

### BRIEF DESCRIPTION OF THE DRAWINGS

FIG. 1 illustrates a portable electronic gaming tablet in accordance with an embodiment of the present invention.

FIG. 2 illustrates a flow diagram for a method for facilitating electronic gaming via a portable electronic gaming tablet in accordance with an embodiment of the present invention.

FIG. 3 illustrates a flow diagram for a method for portable gaming in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Certain embodiments of the present invention provide a portable, indestructible, waterproof tablet for use in wireless gaming system within a casino and/or other gaming environment. The tablet may be carried to other locations adjacent to the casino, as for example, the swimming pool area, allowing the player to participate in live table games on the casino floor or else allowing the player to play non-table games.

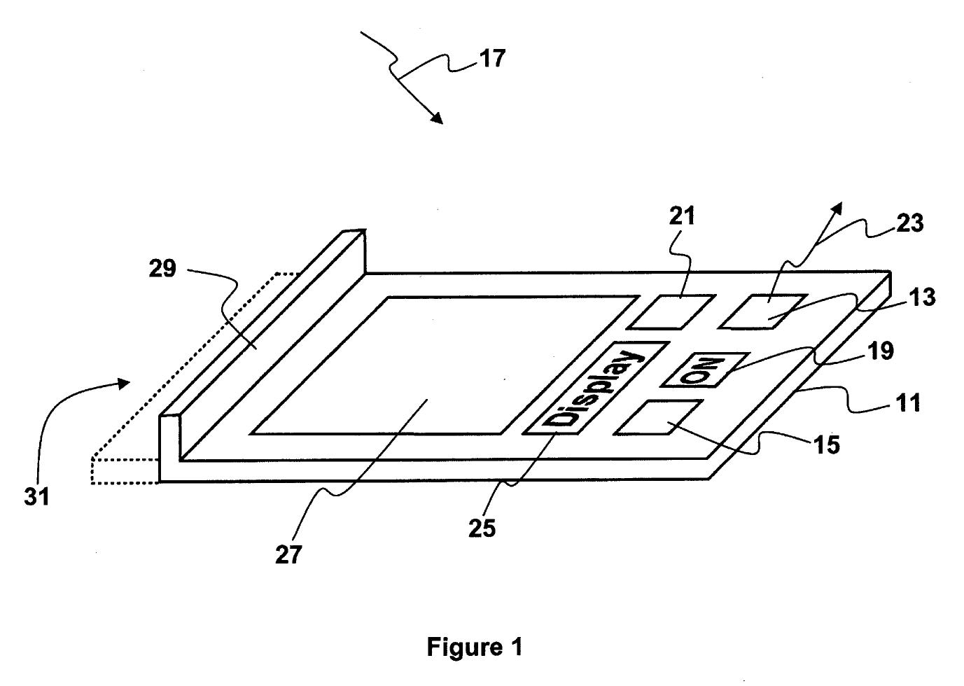

FIG. 1 illustrates a portable electronic gaming tablet which includes a two-way communication device in accordance with an embodiment of the present invention.

Referring to FIG. 1, a tablet 11 includes a two-way communication device 13, such as a transceiver and/or a transmitter and receiver combination providing communication via radio wave, infra-red, microwave, cellular and/or other sound or light wave communication, for example. The tablet 11 allows a player of the tablet 11 to participate in a casino game. The tablet 11 establishes a unique identification number for the tablet 11 so that wager and win information may be accounted. The player's personal identification information, such as their number in the casino loyalty club, is loaded into the tablet 11 by a gaming environment, such as a casino. The tablet 11 may be authorized to participate only within a predefined distance from a defined geographical area, for example. When the tablet 11 moves outside of the area, some parts of the tablet 11 are deactivated. The display screen 25 and/or 27 remains active so that a message may be sent to the player that the tablet 11 has moved outside of the area. In certain embodiments, a check is performed at the tablet 11 to approve its activity. Its geographic location may disqualify the tablet 11 from further play, for example.

In certain embodiments, the tablet 11 can only be used in connection with gaming and access to a particular casino. In other embodiments, the tablet 11 may be used in a plurality of environments, such as in connection with commonly owned casinos, in connection with games and/or gaming machines from a common manufacturer, in connection with a player account, and/or the like.

In addition to gaming, the tablet 11 may be used to provide services, such as securing dinner reservations, ordering food/drink, purchasing theater tickets, requesting a car from a valet, and the like. Also, the casino may provide advertisements and other information directly to the tablet 11 and thus to the player.

The tablet 11 may be operated by a solar, flat battery 15 or other rechargeable or non-rechargeable battery, and/or by wireless power 17, for example. In certain embodiments, the tablet 11 may include an A/C current connection enabling the tablet 11 to draw outlet power as well. A processor and memory (not shown) inside the tablet 11 facilitate operation of tablet functions and remote execution of gaming and/or other applications via the tablet 11. In certain embodiments, the tablet 11 includes a flexible, waterproof housing 12 and flexible circuitry to allow said portable electronic gaming table to be rolled up and/or bent, for example.

In certain embodiment, an on/off area 19 of the tablet 11 is touch activatable by the player. When the tablet 11 is activated, the tablet 11 identifies its geographical location. In addition, a finger may be placed in a certain location 21 on the tablet 11 where biometrics are utilized to identify the player, for example. Alternatively, other biometric information (such as eye sensor, voice recognition, etc.), password/passcode information, and/or authentication information may be used to approve access to and use of the tablet 11. Information is sent from a transmitter/transceiver 13 the tablet 11 along wireless path 23 to a central system and/or other remote processing for retrieving credit information. Identification information may be transferred via radio waves or infra-red radiation, for example, from the portable or handheld device. Credit and/or other information is returned to the tablet 11 along path 23 to receiver/transceiver 13, and then displayed on the tablet 11 at display location 25, and/or display location 27, for example. Game information and/or player information may also be remotely retrieved and displayed via the tablet 11, for example.

In certain embodiments, a touchscreen or touchpad (such as a touchscreen implemented in display area 27), one or more keys and/or buttons, a stylus, voice recognition, and/or input may be provided to facilitate input by a player into the tablet 11.

Using the tablet 11, the player may select, for example, to play a roulette game which is being played in real-time in the casino. The tablet 11 would then provide a diagram representation and/or other graphical representation of the actual roulette table in the casino and/or a live video display or snapshot in display areas 27 and/or 25, including a real time or substantially real time indication of bets placed and location of game sequence.

In certain embodiments, the tablet 11 may, for example, vibrate to give the player actual feedback of ongoing game experience. The player may see the roulette wheel spin and view the ball positioned in real time via display area(s) 25 and/or 27. There may be a bet area on the tablet 11, such as on sensor 21 and/or in a touchscreen display area 25 and/or 27, where chips can be placed by the player. The player may use his finger to drag and drop certain chips onto the roulette board shown in the display area 27, for example. Besides roulette, other games such as poker, craps, blackjack, Pai Gow, Sik Bo, Baccarat, dice game, and/or any other table game may be played via the tablet 11.

Gaming devices may be any electronic gaming machine (EGM) such as a slot machine, fruit machine, video Poker machine, Keno or Bingo machine, or any other electronic gaming device or terminal. Additionally, the tablet 11 may server as a portable electronic gaming machine (EGM) to provide video poker, slot machine, fruit machine, keno, and/or bingo games may be played via the tablet 11. For example, slot reels and other information may be shown to the player via the display area 27, and wager information, player information, and triggering options may be displayed via areas 25 and/or 27.

In addition, the tablet 11 may serve as a booklet or other reference and provide player instructions and/or answers to frequently asked questions that can be pulled up so that the player may view such instructions and/or other information, for example.

In certain embodiments, the tablet 11 is implemented using flexible material such as polymer or plastic to enable the tablet 11 or at least a portion of the tablet 11 to be bent, molded, and/or otherwise positioned such as provided by the Polymer Vision products by Philips (Royal Philips Electronics of the Netherlands).

For example, to play craps, the tablet's edge 29 may be bent upwardly, as shown at 31. Against table edge 29, a player may drag a representation of flick dice which “bounce off” at the bent edge 29 and appear landed on game display area 27 to provide a dice outcome. This provides another interactive “real” feel to the player. Flexible circuitry, thin film displays, electronic ink, and/or other thin, flexible technology may be used to implement such a tablet 11. Alternatively and/or in addition, a ridge or shelf may be placed on the tablet 11 at 31, for example.

In certain embodiments, a sentinel or guard is provided in a gaming environment to monitor data transmissions coming into and/or leaving a particular area. The sentinel may jam or interfere with unauthorized communication in the monitored area, for example. The sentinel may also serve to authorize electronic devices before they can be used for gaming in the monitored area.

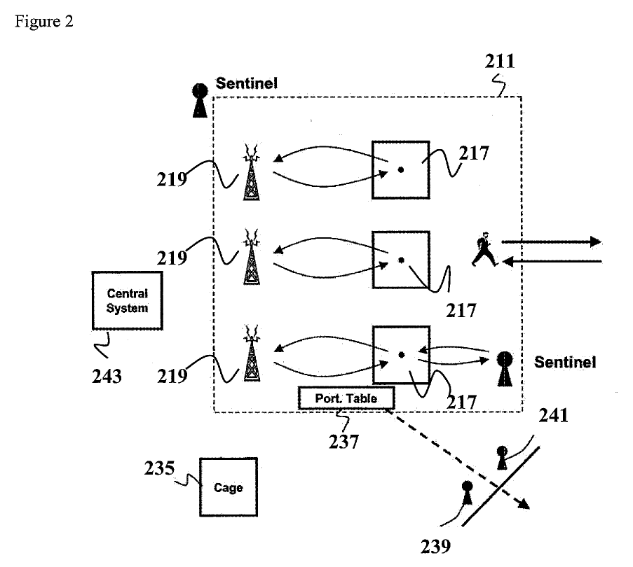

Referring to FIG. 2, a portable gaming table 237 may be moved into and out of area 211. Portable gaming table 237 may be an electronic notebook, pad, tablet, or the like that provides a game display, as an example. When portable gaming table 237 resides inside area 211, it operates properly. Portable gaming table 237 may be moved to, for example, the swimming pool area and continue to operate correctly. However, if the table 237 is moved outside of sentinels 239, 241, where the player leaves the casino, sentinels 239, 241 will turn off table 237.

Each of the tables 237 may have a location sensor, such as a GPS and/or electromagnetic tracking sensor, to monitor locations of the tables 237. If a portable gaming table 237 is removed from a particular designated area, the table 237 is taken or removed from a trusted or authorized table list. Alternatively and/or in addition, an alarm may be sent that the table 237 is no longer able to be activated. To reactivate the table 237, the table 237 must be taken to the casino cage, for example. When the table 237 leaves the area 211, sentinels 239, 241 will turn the table 237 off as well as notify a controller (e.g., central system 243 and/or cage computer 235) and/or associated database that the table 237 has left the area 211. Alternatively and/or in addition, the table 237 itself may identify its location and send a signal to a sentinel 239, 241 when it determines that it is leaving the area 11.

In certain embodiments, the table 237 may be a portable electronic gaming table or tablet for use in wireless gaming within a gaming environment, such as a casino. The table or tablet may be carried to a plurality of locations in and/or adjacent to the gaming environment, as for example, the swimming pool area, allowing the player to participate in live table games occurring on the casino floor or else allowing the player to play non-table games. In certain embodiments, a tablet includes a two-way communication device allowing the player of the tablet to participate in a live casino game. The tablet establishes an identification number for the tablet, for example, so that wager and win information may be accounted. The player's personal identification number is downloaded to the tablet by the casino. The tablet may be authorized to participate only within a predefined distance from a defined geographical area. When the tablet moves outside of the area, some parts of the tablet are deactivated by sentinels 239, 241. In certain embodiments, the tablet display screen remains active so that a message may be sent to the player that the tablet has moved outside of the area. A check is performed at the tablet to approve its activity. Its geographic location may disqualify the tablet from further play, for example. Sentinels 239, 241 may authorize the portable table 237 for use with one or more games 217 facilitated by electronic gaming devices 219, for example.

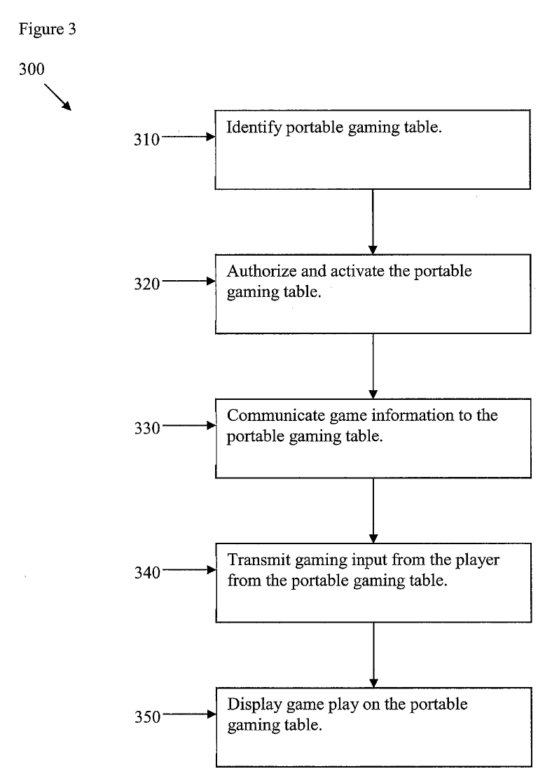

FIG. 3 illustrates a flow diagram for a method 300 for portable gaming in accordance with an embodiment of the present invention. At step 310, a portable gaming table is identified. For example, a sentinel and/or control server (e.g., on-site and/or remote) may be used to receive (e.g., initiated by the portable gaming table and/or requested by the sentinel) identification information from the portable gaming table. Identification information may include a portable gaming table identifier and/or player identification information, such as biometric information, a player identification/account number, a password/passcode, and the like.

At step 320, the portable gaming table is authorized and activated. For example, based on gaming table and/or player identification information, a sentinel and/or control server can determine whether the gaming table and/or player using the portable gaming table is authorized to operate in a certain around and/or with respect to a certain game. The sentinel and/or control server may then transmit an approval to the portable gaming tablet and/or an electronic gaming device facilitating play of a game to which the portable gaming table desires to connect.

At step 330, game information is communicated to the portable gaming table. For example, game display information, wager information, outcome information, and the like is transmitted to the portable gaming table for display and execution for the player.

At step 340, gaming input from the player is transmitted from the portable gaming table. For example, player wager information, handle pull and/or game item selection information, cash out information, etc., is input by the player into the portable gaming table (e.g., via keypad, button, touchscreen, etc.) and transmitted by the portable gaming table to an electronic gaming device facilitating the game play.

At step 350, game play is displayed on the portable gaming table. For example, game outcomes and other game play is displayed on the portable gaming table for the player to view substantially in real time (i.e., with some inherent transmission and/or processing delay) with events occurring at the game location.

One or more of the steps of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

The portable gaming systems and methods described above may be used in conjunction with a variety of gaming systems/environments. The gaming system can take a number of different forms. In a first form, one or more stand alone gaming machines are provided wherein all or most components required for implementing a game are present in a player operable gaming machine. In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisioned. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

In a thick client embodiment, a game server implements part of the game played by a player using a gaming machine and/or portable gaming table, and the gaming machine and/or portable gaming table implements part of the game. With this embodiment, as both the game server and the gaming machine/gaming table implement part of the game, they collectively provide a game controller. A database management server may manage storage of sentinel and chip information, game programs and/or associated data for downloading or access by the gaming devices in a database. Typically, if the gaming system enables players to participate in a Jackpot game, a Jackpot server will be provided to monitor and carry out the Jackpot game.

In a thin client embodiment, the game server implements most or all of the game played by a player using a gaming machine/portable electronic gaming table and the gaming machine/gaming table essentially provides only the player interface. With this embodiment, the game server provides the game controller. The gaming machine/gaming tablet will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components, portable gaming tablets, and/or other electronic gaming devices.

Servers may also be provided to assist in the administration of the gaming system, including for example a gaming floor management server and a licensing server to monitor the use of licenses relating to particular games. An administrator terminal is provided to allow an administrator to monitor the network and the devices connected to the network.

The gaming system may communicate with other gaming systems, other local networks such as a corporate network, and/or a wide area network such as the Internet, for example through a firewall.

Persons skilled in the art will appreciate that in accordance with known techniques, functionality at the server side of the network may be distributed over a plurality of different computers. For example, elements may be run as a single “engine” on one server or a separate server may be provided. For example, the game server could run a random number generator engine. Alternatively, a separate random number generator server could be provided.

The components, elements, and/or functionality of the system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of certain embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of a variety of gaming systems. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

While certain embodiments of the present invention have been described, it should be understood that these embodiments are subject to many modifications and changes without departing from the spirit and scope of the appended claims. For example, it will be understood that the invention disclosed and defined in this specification extends to all alternative combinations of two or more of the individual features mentioned or evident from the text or drawings. All of these different combinations constitute various alternative aspects of the invention. It will also be understood that the term “comprises” (or its grammatical variants) as used in this specification is equivalent to the term “includes” and should not be taken as excluding the presence of other elements or features.

1. A portable gaming system including a portable electronic gaming table, said portable electronic gaming table comprising:
a display providing information to a user, the information including authentication information and game play information;
a two-way communication device transmitting information from the portable electronic gaming table and receiving information relating to authorization and game play at said portable electronic gaming table;
an input mechanism accepting input from the user for user identification, game play and service request; and
a processor facilitating remote identification, authorization and game play in conjunction with a remote electronic gaming device to enable the user to remotely play a casino game within a certain monitored area,
wherein said two-way communication device transmits identification information to said remote electronic gaming device and wherein the processor facilitates remote game play, based on user input and activity at said remote electronic gaming device, in conjunction with said remote electronic gaming device upon receipt of authorization from said remote electronic gaming device.

2. The system of claim 1, wherein said portable electronic gaming table further comprises a biometric sensor accepting input of a user's biometric information for authentication.

3. The system of claim 1, wherein further comprising a sentinel monitoring communication in the certain monitored area and authorizing activation and use of said portable electronic gaming table with said remote electronic gaming device in the monitored area based on said identification information.

4. The system of claim 3, wherein said sentinel activates said portable electronic gaming table within said monitored area and deactivates said portable electronic gaming table when said portable electronic gaming table leaves said monitored area.

5. The system of claim 3, wherein at least a portion said display of said portable electronic gaming table remains active when said portable electronic gaming table is deactivated to notify the user of the status of said portable electronic gaming table.

6. The system of claim 3, wherein said sentinel blocks data transmissions entering said monitored area that originate outside of said monitored area.

7. The system of claim 1, wherein said remote electronic gaming device is associated with a casino game and facilitates game play between said portable electronic gaming system and said casino game.

8. The system of claim 1, further comprising a database including identification information for use in verifying and authorizing use of said portable electronic gaming table.

9. The system of claim 1, wherein said portable electronic gaming table further comprises a touchscreen display.

10. The system of claim 1, wherein said portable electronic gaming table further comprises a flexible, waterproof housing and flexible circuitry to allow said portable electronic gaming table to be rolled up.

11. A method for portable, remote game play in a gaming environment using a portable gaming table and an electronic gaming device, said method comprising:
transmitting an identification signal from a portable gaming table to an electronic gaming device;
receiving an authorization signal from the electronic gaming device at the portable gaming table;
receiving game information from the electronic gaming device at the portable gaming table;
transmitting user input regarding wagering and game play from the portable gaming table to the electronic gaming device; and
facilitating remote game play between the portable gaming table and the electronic gaming device based on user input at the portable gaming table and activity at said electronic gaming device.

12. The method of claim 11, wherein said step of receiving an authorization signal further comprises receiving the authorization signal based on monitoring and approval by a sentinel in a certain monitored area.

13. The method of claim 12, wherein said sentinel activates said portable gaming table within said monitored area and deactivates said portable gaming table when said portable gaming table leaves said monitored area.

14. The method of claim 11, further comprising interfering with transmissions entering said monitored area that originate outside of said monitored area.

15. The method of claim 11, further comprising:
turning on said portable gaming table within said monitored area based on said authorization signal; and
turning off said portable gaming table when said portable gaming table leaves said monitored area.

16. A system for mobile game play, said system comprising:
a gaming processor facilitating game play in a gaming environment, said gaming processor adapted to facilitate both in-person game play and mobile game play within a certain monitored area;
a sentinel monitoring data transmissions in the certain monitored area, said sentinel authorizing activation of electronic devices in the certain monitored area based on an authentication of electronic device identity; and
a portable electronic gaming device for mobile game play, said portable electronic gaming device adapted to provide identification information to said sentinel for authentication and adapted to provide game play input to said gaming processor to facilitate mobile game play,
wherein, upon authorization of said portable electronic gaming device for activation by said sentinel, said processor facilitates remote game play based on user input and activity at said portable electronic gaming device and at said gaming processor.

17. The system of claim 16, wherein said sentinel activates said portable electronic gaming device within said certain monitored area and deactivates said portable electronic gaming device when said portable electronic gaming device leaves said certain monitored area.

18. The system of claim 17, wherein at least a portion said display of said portable electronic gaming device remains active when said portable electronic gaming device is deactivated to notify the user of the status of said portable electronic gaming device.

21. The system of claim 16, wherein said sentinel blocks data transmissions entering said certain monitored area that originate outside of said certain monitored area.

20. The system of claim 16, wherein said portable electronic gaming device further comprises a flexible edge capable of being bent upwardly for game play.

21. The system of claim 16, wherein said portable electronic gaming device further comprises a flexible, waterproof housing and flexible circuitry to allow said portable electronic gaming device to be rolled up.
